(19) United States
(12) Patent Application Publication
(10) Pub. No.: US 2016/0053681 A1
(43) Pub. Date: Feb. 25, 2016

(54) LIQUID FUEL COMBUSTOR HAVING AN OXYGEN-DEPLETED GAS (ODG) INJECTION SYSTEM FOR A GAS TURBOMACHINE

(71) Applicant: General Electric Company, Schenectady, NY (US)

(72) Inventors: William Francis Carnell, JR., Greer, SC (US); Ilya Aleksandrovich Slobodyanskiy, Greenville, SC (US)

(21) Appl. No.: 14/464,032

(22) Filed: Aug. 20, 2014

(51) Int. Cl. F02C 3/24; F23R 3/30; F02C 3/34

(52) U.S. Cl. CPC F02C 3/24; F02C 3/34; F23R 3/30

(57) ABSTRACT

A liquid fuel combustor for a gas turbomachine includes a combustor body, a combustor liner arranged in the combustor body defining a combustion chamber extending from a head end to a combustor discharge. The combustor liner is spaced from the combustor body forming a compressor discharge casing (CDC) airflow passage. A nozzle is arranged at the head end of the combustor liner. The nozzle includes a first inlet, a second inlet and an outlet configured and disposed to establish a flame zone. The first inlet is configured to receive a first fluid and the second inlet is configured to receive a second fluid. The second fluid includes a liquid fuel. An oxygen-depleted gas (ODG) injection system is arranged radially outwardly of the nozzle. The ODG injection system is configured and disposed to deliver an oxygen-depleted gas stream into the combustion chamber to vaporize a portion of the second fluid.

### BACKGROUND OF THE INVENTION

The subject matter disclosed herein relates to the art of turbomachines and, more particularly, to a liquid fuel combustor having an oxygen-depleted gas (ODG) injection system for a gas turbomachine.

Turbomachines typically include a compressor portion and a turbine portion. The compressor portion forms a compressed air stream that is introduced into the turbine portion. In a gas turbomachine, a portion of the compressed airstream mixes with products of combustion forming a hot gas stream that is introduced into the turbine portion through a transition piece. In some cases, the products of combustion include un-combusted constituents that contribute to undesirable emissions.

The hot gas stream impacts turbomachine airfoils arranged in sequential stages along the hot gas path. The airfoils are generally connected to a wheel which, in turn, may be connected to a rotor. Typically, the rotor is operatively connected to a load. The hot gas stream imparts a force to the airfoils causing rotation. The rotation is transferred to the rotor. Thus, the turbine portion converts thermal energy from the hot gas stream into mechanical/rotational energy that is used to drive the load. The load may take on a variety of forms including a generator, a pump, an aircraft, a locomotive or the like.

In some cases, combustors may combust liquid fuels such as heavy fuel oil (HFO) or a combination of liquid and gaseous fuels. Liquid fuels are generally atomized upon introduction to the combustion chamber. Atomization of the liquid fuels produces droplets that are exposed to an ignition source and combusted. In some cases, larger droplets tend to migrate radially outward and may remain un-combusted. Un-combusted fuel may flow through the turbomachine and exit with exhaust gases contributing to emissions such as CO, unburned hydrocarbons, or UHC, and the like that are currently subject to regulation.

### BRIEF DESCRIPTION OF THE INVENTION

According to one aspect of an exemplary embodiment, a liquid fuel combustor for a gas turbomachine includes a combustor body and a combustor liner arranged in the combustor body defining a combustion chamber extending from a head end to a combustor discharge. The combustor liner is spaced from the combustor body forming a compressor discharge casing (CDC) airflow passage. At least one nozzle is arranged at the head end of the combustor liner. The at least one nozzle includes a first inlet, a second inlet, and an outlet configured and disposed to establish a flame zone. The first inlet is configured to receive a first fluid and the second inlet is configured to receive a second fluid. The second fluid includes a liquid fuel. An oxygen-depleted gas (ODG) injection system is arranged radially outwardly of the at least one nozzle. The ODG injection system is configured and disposed to deliver an oxygen-depleted gas stream into the combustion chamber to vaporize a portion of the second fluid.

According to another aspect of an exemplary embodiment, a gas turbomachine includes a compressor portion, a turbine portion operatively connected to the compressor portion, and a combustor assembly including at least one liquid fuel combustor fluidically connecting the compressor portion and the turbine portion. The at least one liquid fuel combustor includes a combustor body and a combustor liner arranged in the combustor body defining a combustion chamber extending from a head end to a combustor discharge. The combustor liner is spaced from the combustor body forming a compressor discharge casing (CDC) airflow passage. At least one nozzle is arranged at the head end of the combustor liner. The at least one nozzle includes a first inlet, a second inlet, and an outlet configured and disposed to establish a flame zone. The first inlet is configured to receive a first fluid and the second inlet is configured to receive a second fluid. The second fluid includes a liquid fuel. An oxygen-deplete gas (ODG) injection system is arranged radially outwardly of the at least one nozzle. The ODG injection system is configured and disposed to deliver an oxygen-depleted gas stream into the combustion chamber to vaporize a portion of the second fluid.

According to yet another aspect of an exemplary embodiment, a gas turbomachine system includes a compressor portion, a turbine portion operatively connected to the compressor portion, an air inlet system fluidically connected to the compressor portion, a load operatively connected to one of the compressor portion and the turbine portion and a combustor assembly including at least one liquid fuel combustor fluidically connecting the compressor portion and the turbine portion. The at least one liquid fuel combustor includes a combustor body and a combustor liner arranged in the combustor body defining a combustion chamber extending from a head end to a combustor discharge. The combustor liner is spaced from the combustor body forming a compressor discharge casing (CDC) airflow passage. At least one nozzle is arranged at the head end of the combustor liner. The at least one nozzle includes a first inlet, a second inlet, and an outlet configured and disposed to establish a flame zone. The first inlet is configured to receive a first fluid and the second inlet is configured to receive a second fluid. The second fluid includes a liquid fuel. An oxygen-depleted gas (ODG) injection system is arranged radially outwardly of the at least one nozzle. The ODG injection system is configured and disposed to deliver an oxygen-depleted gas stream into the combustion chamber to vaporize a portion of the second fluid in oxygen-depleted combustion products.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine system including a combustor having an oxygen-depleted gas (ODG) injection system, in accordance with an exemplary embodiment;

FIG. 2 is a partial cross-sectional view of the combustor of FIG. 1;

FIG. 3 is a partial cross-sectional view of a head end of the combustor of FIG. 2, in accordance with an aspect of an exemplary embodiment; and

FIG. 4 is a partial cross-sectional view of a head end of the combustor of FIG. 2.

The detailed description explains embodiments of the invention, together with advantages and features, by way of example with reference to the drawings.

### DETAILED DESCRIPTION OF THE INVENTION

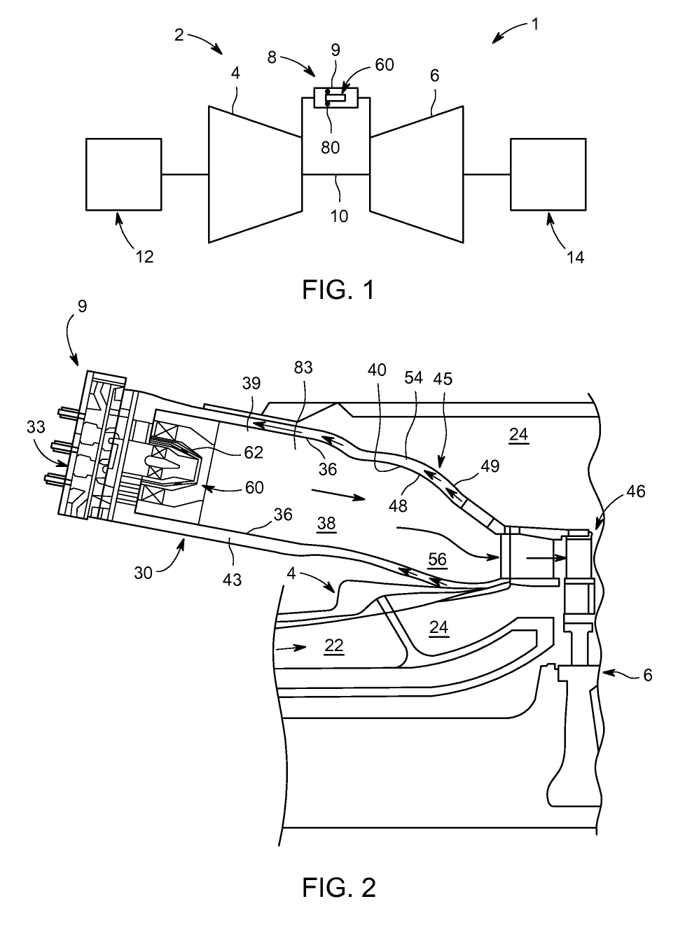

With initial reference to FIGS. 1 and 2, a turbomachine system is indicated generally at 1. Turbomachine system 1 includes a turbomachine 2 having a compressor portion 4 connected to a turbine portion 6 through a combustor assembly 8 including at least one liquid fuel combustor 9. Compressor portion 4 is also connected to turbine portion 6 via a common compressor/turbine shaft 10. An air inlet system 12 is fluidically connected to an inlet (not separately labeled) of compressor portion 4. A load, indicated generally at 14, is operatively connected to turbine portion 6. Load 14 may take on a variety of forms including generators, pumps, locomotive systems, and other driven loads. Turbine portion 6 may also be connected to an exhaust system (not shown).

Compressor portion 4 includes a diffuser 22 and a compressor discharge plenum 24 that are coupled in fluidic communication with each other and combustor assembly 8. With this arrangement, compressed air is passed through diffuser 22 and compressor discharge plenum 24 into combustor assembly 8. The compressed air is mixed with fuel and combusted to form hot gases. The hot gases are channeled to turbine portion 6. Turbine portion 6 converts thermal energy from the hot gases into mechanical/rotational energy.

Liquid fuel combustor 9 includes a combustor body 30 having a combustor cap 33 and a combustor liner 36. As shown, combustor liner 36 is positioned radially inward from combustor body 30 so as to define a combustion chamber 38. Combustion chamber 38 extends from a head end 39 to a compressor discharge 40. Combustor liner 36 is spaced from combustor body 30 forming a compressor discharge casing (CDC) airflow passage 43. A transition piece 45 connects combustor assembly 8 to turbine portion 6. Transition piece 45 channels combustion gases generated in combustion chamber 38 downstream towards a first stage (not separately labeled) of turbine portion 6. Transition piece 45 may include an inner wall 48 and an outer wall 49 that define an annular passage 54 that fluidically connects with CDC airflow passage 43. Inner wall 48 may also define a guide cavity 56 that extends between combustion chamber 38 and turbine portion 6. A nozzle assembly 60 is arranged at head end 39 of combustor liner 36. Nozzle assembly 60 includes at least one nozzle indicated at 62.

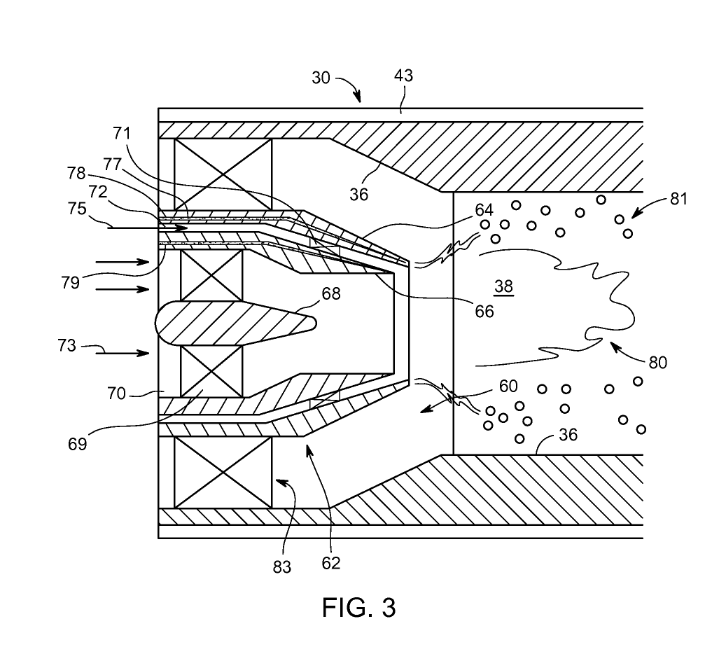

In accordance with an aspect of an exemplary embodiment illustrated in FIG. 3, nozzle 62 includes an outer nozzle member 64, an intermediate nozzle member 66 arranged radially inwardly of outer nozzle member 64, and an inner nozzle member 68 arranged radially inwardly of intermediate nozzle member 66. A first support 69 is arranged between intermediate nozzle member 66 and inner nozzle member 68 creating a first passage 70. A second support 71 is arranged between intermediate nozzle member 66 and outer nozzle member 64 forming a second passage 72. In addition to forming first and second passages 70 and 72, first and second supports 69 and 71 may induce a swirl to fluid flowing therein. A first fluid 73, for example air, is introduced into first passage 70. A second fluid 75, for example heavy fuel oil (HFO), is introduced into second passage 72. In addition, a cooling fluid 77, for example water, is passed through cooling fluid passages 78 and 79 formed in respective ones of outer nozzle member 64 and inner nozzle member 68. Cooling fluid 77 enters inlets (not separately labeled) of respective ones of passages 78 and 79 and passes through respective outlets (also not separately labeled) into combustion chamber 38. First and second fluids 73 and 75 mix to form a combustible mixture (not separately labeled) that is ignited to form a flame zone 80. A portion of the second fluid 75, shown in the form of droplets 81, may migrate radially outwardly in combustion chamber 38 and remain un-combusted.

In accordance with an aspect of an exemplary embodiment, liquid fuel combustor 9 includes an oxygen-depleted gas (ODG) injection system 83 arranged radially outwardly of nozzle 62. ODG injection system 83 introduces a hot oxygen-depleted gas stream into combustion chamber 38. The oxygen-depleted gas stream may be at a temperature in a range of 250° F. (121° C.) to 1800° F. (982° C.) and facilitates combustion of un-combusted fuel particles, such as droplets 81 that may migrate radially outwardly of flame zone 80. Of course, it should be understood that the temperature range may vary. Oxygen-depleted gases may originate at liquid fuel combustor 9, or may be introduced from a different source. Regardless of the source of the oxygen-depleted gas, ODG injection system 83 promotes more complete vaporization of the combustible mixture to reduce emissions, such as NOx.

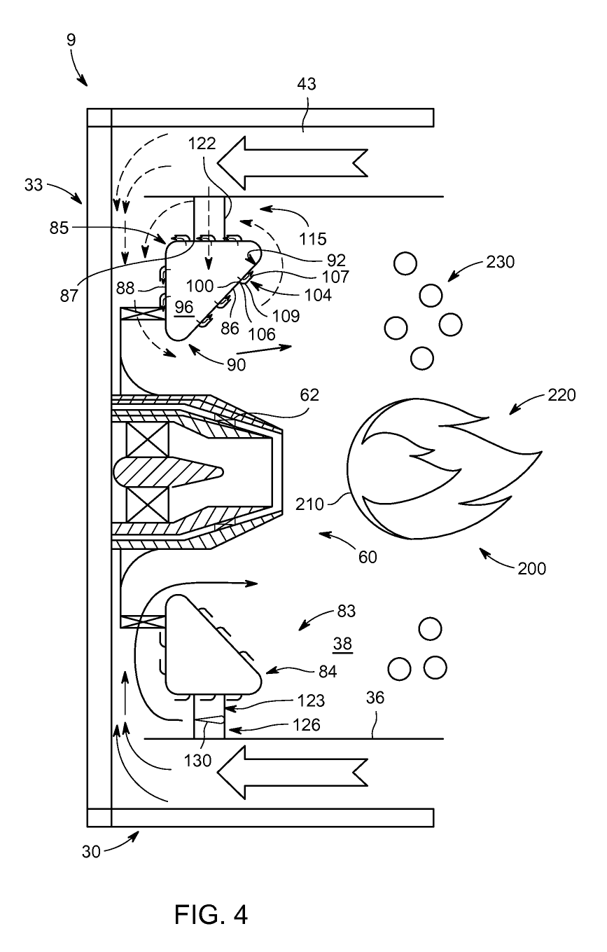

In accordance with an aspect of an exemplary embodiment, ODG injection system 83 takes the form of a recirculation member 84 arranged at head end 39, as shown in FIG. 4. Recirculation member 84 includes a body 85 having a first surface section 86, a second surface section 87, and a third surface section 88 that collectively define an outer surface 90 and an inner surface 92. First surface section 86 extends substantially parallel to combustor cap 33, second surface section 87 extends substantially parallel to combustor liner 36, and third surface section 88 extends radially inwardly from second surface section 87 to first surface section 86. Of course, it should be understood that the overall geometry of body 85 may vary.

In further accordance with an exemplary embodiment, inner surface 92 defines an interior cavity 96. A plurality of openings, one of which is shown at 100, extend through each of first, second, and third surface sections 86-88 fluidically connecting interior cavity 96 and combustion chamber 38. A plurality of guide elements, one of which is indicated at 104, are mounted to outer surface 90 at each of the plurality of openings 100. Each guide element 104 extends from a first end 106, coupled to outer surface 90, to a second, cantilevered end 107 through a bend portion 109. As will be discussed more fully below, guide elements 104 direct fluid passing from interior cavity 96 to flow along one of first, second, and third surface sections 86-88.

In still further accordance with an exemplary embodiment, liquid fuel combustor 9 includes a recirculation passage 115 arranged radially outwardly of recirculation member 84. A plurality of conduits, two of which are shown at 122 and 123, fluidically connect CDC airflow passage 43 and interior cavity 96. One or more of the plurality of conduits 122 and 123 may constitute an aerodynamically shaped vane 126. Specifically, one or more of conduits 122 and 123 may include an aerodynamically shaped cross-section in the shape of an airfoil, such as shown at 130. Of course, aerodynamically shaped vane 126 may include other profile geometries. Aerodynamically shaped vane 126 conditions an oxygen-depleted flow passing from combustion chamber 38 through recirculation passage 115, as will be detailed more fully below.

In accordance with an aspect of an exemplary embodiment, a flame 200 is established in combustion chamber 38. Flame 200 includes a base or root 210 arranged proximate to nozzle 62. Flame 200 establishes a flame zone 220 in which oxygen-depleted combustion products, such as NOx, are formed. Generally, the oxygen-depleted combustion products migrate radially outwardly in combustion chamber 38 toward combustor liner 36. In order to enhance combustor efficiency and reduce emissions, the oxygen-depleted combustion products are directed back into combustion chamber 38 toward un-combusted droplets 230 that may migrate radially outwardly of flame zone 220 and toward root 210 of flame 200 to enhance combustion.

More specifically, compressor air flowing through CDC airflow passage 43 passes into interior cavity 96 of recirculation member 84. The compressor air passes through openings 100 and is guided by guide element 104 about recirculation member 84 forming a low pressure zone (not separately labeled) at recirculation passage 115. The oxygen-depleted combustion products are drawn toward the low pressure zone and pass through recirculation passage 115. The oxygen-depleted combustion products mix with the compressor air and pass back into combustion chamber 38 to enhance combustion of un-combusted fuel particles/droplets. In accordance with an aspect of the exemplary embodiment, the oxygen-deplete gas captures/transports droplets 230 back toward a base of flame 200.

In accordance with another aspect of an exemplary embodiment, the compressor air trips over a corner (not separately labeled) formed at a junction of first surface section 86 and second surface section 87 creating the low pressure zone. In accordance with another aspect of an exemplary embodiment, aerodynamically shaped vanes 126 reduce drag on the oxygen-depleted combustion products passing through recirculation passage 115 to enhance flow into combustion chamber 38.

At this point it should be understood that the exemplary embodiments describe a combustor having an oxygen-depleted gas (ODG) injection system that introduces an oxygen-depleted gas back into the combustion chamber to promote combustion of un-combusted fuel particles. The oxygen-depleted gas may originate in combustion chamber 38, may mix with compressor gas, or may be introduced from a remote source. Regardless of the source, the oxygen-depleted gas mixes with un-combusted fuel particles to promote combustion. In accordance with one aspect of the exemplary embodiment, the oxygen-depleted gases may mix with, capture, and carry the un-combusted fuel particles back toward a base of a combustor flame to improve combustor efficiency and reduce emissions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A liquid fuel combustor for a gas turbomachine comprising:
a combustor body;
a combustor liner arranged in the combustor body defining a combustion chamber extending from a head end to a combustor discharge, the combustor liner being spaced from the combustor body forming a compressor discharge casing (CDC) airflow passage;
at least one nozzle arranged at the head end of the combustor liner, the at least one nozzle including a first inlet, a second inlet and an outlet configured and disposed to establish a flame zone, the first inlet configured to receive a first fluid and the second inlet configured to receive a second fluid, the second fluid including a liquid fuel; and
an oxygen-depleted gas (ODG) injection system arranged radially outwardly of the at least one nozzle, the ODG injection system being configured and disposed to deliver an oxygen-depleted gas stream into the combustion chamber to vaporize a portion of the second fluid.

2. The liquid fuel combustor according to claim 1, wherein the ODG injection system includes at least one recirculation member arranged at the head end of the combustor liner, the at least one recirculation member being configured and disposed to guide oxygen-depleted combustion products from the flame zone back to the outlet of the at least one nozzle.

3. The liquid fuel combustor according to claim 2, wherein the at least one recirculation member includes an outer surface and an inner surface that defines an interior cavity.

4. The liquid fuel combustor according to claim 3, wherein the interior cavity is fluidically connected to the CDC airflow passage.

5. The liquid fuel combustor according to claim 3, wherein the at least one recirculation member includes a plurality of openings extending through the inner and outer surfaces fluidically connecting the interior cavity and the combustion chamber.

6. The liquid fuel combustor according to claim 5, wherein the at least one recirculation member includes a plurality of guide elements arranged at respective ones of the plurality of openings on the outer surface.

7. The liquid fuel combustor according to claim 3, further comprising: a recirculation passage arranged radially outwardly of the at least one recirculation member.

8. The liquid fuel combustor according to claim 7, wherein the recirculation passage is defined between the at least one recirculation member and the combustor liner.

9. The liquid fuel combustor according to claim 7, further comprising: an aerodynamically shaped vane arranged in the recirculation passage.

10. The liquid fuel combustor according to claim 7, further comprising: at least one conduit extending from the combustor liner to the at least one recirculation member, the at least one conduit fluidically connecting the CDC airflow passage and the interior cavity.

11. The liquid fuel combustor according to claim 2, wherein the at least one recirculation member extends radially outwardly of, and about, the at least one nozzle.

12. The liquid fuel combustor according to claim 1, further comprising: a cooling fluid passage arranged in the at least one nozzle, the cooling fluid passage including an inlet and an outlet fluidically connected to the combustion chamber.

13. A gas turbomachine comprising:
a compressor portion;
a turbine portion operatively connected to the compressor portion; and
a combustor assembly including at least one liquid fuel combustor fluidically connecting the compressor portion and the turbine portion, the at least one liquid fuel combustor comprising:
a combustor body;
a combustor liner arranged in the combustor body defining a combustion chamber extending from a head end to a combustor discharge, the combustor liner being spaced from the combustor body forming a compressor discharge casing (CDC) airflow passage;
at least one nozzle arranged at the head end of the combustor liner, the at least one nozzle including a first inlet, a second inlet and an outlet configured and disposed to establish a flame zone, the first inlet configured to receive a first fluid and the second inlet configured to receive a second fluid, the second fluid including a liquid fuel; and
an oxygen-deplete gas (ODG) injection system arranged radially outwardly of the at least one nozzle, the ODG injection system being configured and disposed to deliver an oxygen-depleted gas stream into the combustion chamber to vaporize a portion of the second fluid.

14. The gas turbomachine according to claim 13, wherein the ODG injection system includes at least one recirculation member arranged at the head end of the combustor liner, the at least one recirculation member being configured and disposed to guide oxygen-depleted combustion products from the flame zone back to the outlet of the at least one nozzle.

15. The gas turbomachine according to claim 14, wherein the at least one recirculation member includes an outer surface and an inner surface that defines an interior cavity.

16. The gas turbomachine according to claim 15, wherein the interior cavity is fluidically connected to the CDC airflow passage.

17. The gas turbomachine according to claim 15, wherein the at least one recirculation member includes a plurality of openings extending through the inner and outer surfaces fluidically connecting the interior cavity and the combustion chamber and a plurality of guide elements arranged at respective ones of the plurality of openings on the outer surface.

18. The gas turbomachine according to claim 13, further comprising: a cooling fluid passage arranged in the at least one nozzle, the cooling fluid passage including an inlet and an outlet fluidically connected to the combustion chamber.

19. A gas turbomachine system comprising:
a compressor portion;
a turbine portion operatively connected to the compressor portion;
an air inlet system fluidically connected to the compressor portion;
a load operatively connected to one of the compressor portion and the turbine portion; and
a combustor assembly including at least one liquid fuel combustor fluidically connecting the compressor portion and the turbine portion, the at least one liquid fuel combustor comprising:
a combustor body;
a combustor liner arranged in the combustor body defining a combustion chamber extending from a head end to a combustor discharge, the combustor liner being spaced from the combustor body forming a compressor discharge casing (CDC) airflow passage;
at least one nozzle arranged at the head end of the combustor liner, the at least one nozzle including a first inlet, a second inlet and an outlet configured and disposed to establish a flame zone, the first inlet configured to receive a first fluid and the second inlet configured to receive a second fluid, the second fluid including a liquid fuel; and
an oxygen-depleted gas (ODG) injection system arranged radially outwardly of the at least one nozzle, the ODG injection system being configured and disposed to deliver an oxygen-depleted gas stream into the combustion chamber to vaporize a portion of the second fluid in oxygen-depleted combustion products.

20. The gas turbomachine system according to claim 19, wherein the ODG injection system includes at least one recirculation member arranged at the head end of the combustor liner, the at least one recirculation member being configured and disposed to guide oxygen-depleted combustion products from the flame zone back to the outlet of the at least one nozzle.
